(19) United States
(12) Patent Application Publication
(10) Pub. No.: US 2001/0023504 A1
(43) Pub. Date: Sep. 27, 2001

(54) Flexible buffing cell and sports protector made from the cell

(76) Inventor: Oh Jang Yoon, Ontario (CA)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(21) Appl. No.: 09/836,526

(22) Filed: Apr. 17, 2001

Related U.S. Application Data
(63) Continuation of application No. PCT/KR98/00318, filed on Oct. 19, 1998.

(51) Int. Cl. A41D 1/00; F41H 1/00; G21F 3/02; A62B 17/00

(52) U.S. Cl. 2/455

(57) ABSTRACT

This invention is intended to propose a buffing cell that can provide very high damping effect while having a small weight per a unit volume, and that can be divided into a plurality of pieces without deteriorating the damping effect. The buffing cell 10 comprises a pneumatic chamber 14 defined by a flexible nonwoven fabric 11 and a vinyl film 13 airtightly attached to the fabric 11, and a mass of sponge 12 housed in the pneumatic chamber 14. A sponge layer 12a attached to an outer face of the pneumatic chamber 14 may be used instead of the mass of sponge 12 housed in the pneumatic chamber 14. A sports protector can be made from a plurality of the buffing cells 10.

### CROSS-REFERENCE TO RELATED APPLICATION

This application is a continuation of International Application No. PCT/KR98/00318, filed Oct. 19, 1998, the disclosure of which is incorporated herein by reference.

### BACKGROUND OF THE INVENTION

This invention relates to a buffing cell, more specifically, the buffing cell that can provide very high damping effect while having a small weight per a unit volume, and that can be divided into a plurality of pieces without deteriorating the damping effect. This invention also relates to a sports protector made from a plurality of the buffing cells.

Material used in a sports protector is required to have not only an enough impact-absorbing property but also flexibility adequate to provide a wearer with a full activity. Rubber is usually used as an impact-absorbing material for a sports protector. However, rubber has a considerably large weight per a unit volume and is not easily bent. Accordingly, a sports protector made from a rubber plate considerably limits a wear's activity. Moreover, the rubber plate does not absorb an impact exerted on a face thereof but disperse the impact throughout the area.

Other conventional protectors were made from a hard material that had been divided into several pieces. However, such a small piece can neither absorb nor disperse the impact, because of the limited area.

Accordingly, there is required an impact-absorbing material that can be divided into a plurality of small pieces without deteriorating damping effect, whereby a sports made from the material can provide a wearer with a full activity.

### BRIEF SUMMARY OF THE INVENTION

This invention is intended to solve the aforementioned problems by proposing a buffing cell that can provide very high damping effect while having a small weight per a unit volume, and that can be divided into a plurality of pieces without deteriorating the damping effect.

This invention is also intended to propose many kinds of comfortable sports protectors made from a plurality of such buffing cells.

According to the invention, the buffing cell comprises a pneumatic chamber defined by flexible skins, and an elastically compressible layer associated with the pneumatic chamber.

The elastically compressible layer may be an elastic member housed in the pneumatic chamber.

The elastically compressible layer may also be an elastic member attached on at least an outer face of the pneumatic chamber.

Furthermore, the sports protectors provided according to this invention are made from a plurality of the buffing cells connected with each other. Each buffing cell comprises skin members formed of flexible material, and an elastic member disposed among said skin members. The skin members cooperate to define an airtight chamber with each other, in which said elastic member is contained. Furthermore, two adjoining cells are spaced at a distance in most part of the thickness except for only a thin connector.

One of the sports protectors is a mitt consisting of a struck portion and a grip, wherein said struck portion comprise a plurality of the buffing cells arranged in two layers, and a reinforced frame, while the grip comprise a plurality of the buffing cells and a hard core.

Another of the sports protectors is an upper body protector consisting of front, rear, left and right parts. The front part is connected with said rear part at its top side, said left part at its left side and said right part at its right side. A head insertion opening is formed between said front and rear parts. The rear, left and right parts are connected with each other by attachable/detachable fasteners. Anyone of the front, rear, left and right parts may comprise a plurality of the buffing cells. Furthermore, the buffing cells may be arranged in two layers.

Another of the sports protectors is a forearm protector comprising an impact-absorbing panel having area for surrounding at least a portion of the forearm, wherein said impact-absorbing panel consists of a plurality of the buffing cells.

Another of the sports protectors is a groin protector comprising a groin cover to be worn over the groin and an impact-absorbing panel formed to cover the abdominal region, wherein said impact-absorbing panel consists of a plurality of the buffing cells.

Another of the sports protectors is a shank protector. The shank protector comprises an impact-absorbing panel having area for surrounding at least a portion of the shank, and another impact-absorbing panel having area for covering at least a portion of the instep. Both impact-absorbing panels consist of a plurality of the buffing cells.

Another of the sports protectors is a headgear. The headgear comprises a first impact absorber formed to surround at least a side portion of the head, and a second impact absorber formed to close a top opening surrounded by said first impact absorber. Two ear insertion openings are formed in said first impact absorber. Both impact absorbers consist of a plurality of the buffing cells.

Another of the sports protectors is a breast protector comprising two cup-shaped impact absorbers to be worn on the breasts of a woman, wherein both impact absorbers consist of a plurality of the buffing cells.

Other advantages and features of the present invention will become apparent from the following description, including the drawings and claims.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

In the drawings:

FIG. 1 shows a sectional view of a buffing cell according to an embodiment of this invention;

FIG. 2 shows a sectional view of a buffing cell according to another embodiment of this invention;

FIG. 3 shows a plurality of the buffing cells showed in FIG. 1 for explaining a mode of connection between the buffing cells;

FIG. 4 shows a front elevation of a mitt made from a plurality of the buffing cells showed in FIG. 1 according to another embodiment of this invention, in which a portion of a cover of the mitt is cut out;

FIG. 5 shows a front elevation of an upper body protector made from a plurality of the buffing cells showed in FIG. 1 according to another embodiment of this invention, in which a portion of a cover of the upper body protector is cut out;

FIG. 6 shows a rear elevation of the upper body protector showed in FIG. 5;

FIG. 7 shows a sectional view of a forearm protector made from a plurality of the buffing cells showed in FIG. 1 according to another embodiment of this invention;

FIG. 8 shows a front elevation of a groin protector made from a plurality of the buffing cells showed in FIG. 1 according to another embodiment of this invention, in which a portion of a cover of the groin protector is cut out;

FIG. 9 shows a front elevation of a shank protector made from a plurality of the buffing cells showed in FIG. 1 according to another embodiment of this invention, in which a portion of a cover of the shank protector is cut out;

FIG. 10 shows a rear elevation of the shank protector showed in FIG. 9;

FIG. 11 shows a front elevation of a head protector made from a plurality of the buffing cells showed in FIG. 1 according to another embodiment of this invention, in which a portion of a cover of the head protector is cut out; and

FIG. 12 shows a front elevation of a breast protector made from a plurality of the buffing cells showed in FIG. 1 according to another embodiment of this invention, in which a portion of a cover of the breast protector is cut out.

### DETAILED DESCRIPTION OF THE INVENTION

Hereinafter, preferred embodiments of the buffing cell and the sports protectors according to this invention will be specifically explained referring to the attached drawings.

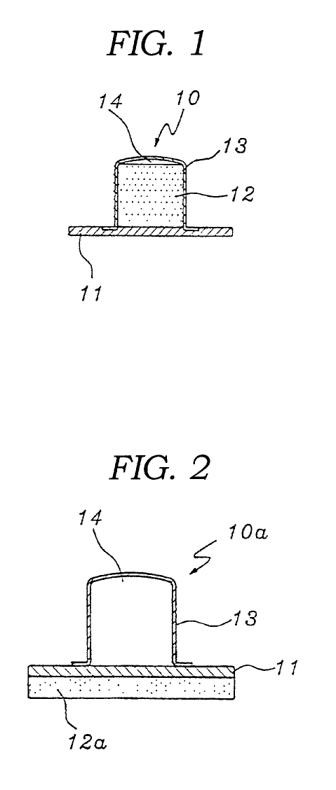

As showed in FIG. 1, a buffing cell 10 according to a preferred embodiment of this invention comprises a pneumatic chamber 14 defined by a flexible nonwoven fabric 11 and a vinyl film 13 airtightly attached to the fabric 1 1, and a mass of sponge 12 housed in the pneumatic chamber 14. The fabric 1 1 is managed to get an airtight property in advance.

The pneumatic chamber 14 damps an impact force exerted on an outer face thereof by heightening a pneumatic pressure therein, and transmits only a weakened force through the opposite side. The sponge 12 also damps an impact force exerted on an outer face thereof by a compressive strain energy, and transmits only a remained force through the opposite side. Normally, a damping action of the sponge 12 cooperate with a damping action of the pneumatic chamber 14 to enhance damping effects, while the sponge 12 acts to a necessary absorber in an abnormal state that the pneumatic chamber 14 is burst. An initial pressure prevailing in the pneumatic chamber 14 is adjusted in accordance to intensity of an impact exerted in use.

Size and shape of the buffing cell 10 can be also adjusted in use.

Meanwhile, another embodiment of the buffing cell 10a is showed in FIG. 2. The buffing cell 10a of this embodiment is same with the buffing cell 10 of the foregoing embodiment, except that the buffing cell 10a of this embodiment comprises a sponge layer 12a attached to an outer face of the pneumatic chamber 14 instead of the mass of sponge 12 housed in the pneumatic chamber 14 in the foregoing embodiment.

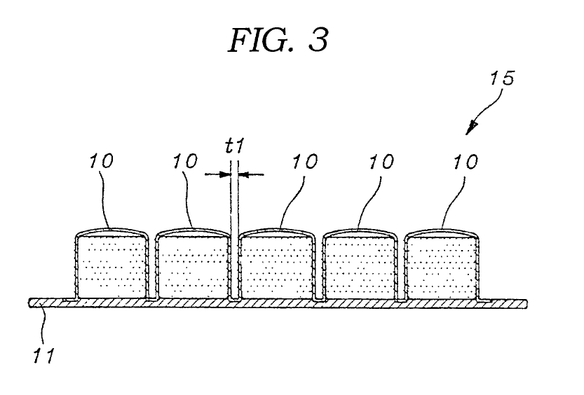

An impact-absorbing panel 15 having varieties of size and shape can be formed by connecting the buffing cells 10 or 10a showed in FIG. 1 or 2. As showed in FIG. 3, the buffing cells 10 are connected only at a portion of the fabric 11 without any connection on the vinyl film 13 that occupies most of the thickness of the buffing cell 10. Moreover, vinyl film portions of adjacent buffing cells 10 are spaced at a distance t1 so that the impact-absorbing panel 15 has an appropriate flexibility.

Hereinafter, various sports protectors made from the aforementioned buffing cells will be explained.

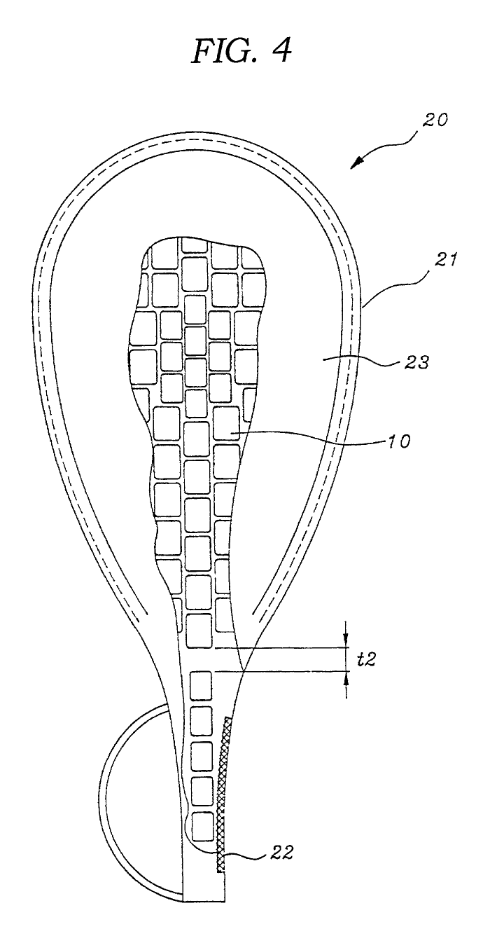

A mitt 20 as one of the sports protectors is showed in FIG. 4.

The mitt 20 is used as a target to be hit in grapple training. As showed in FIG. 4, the mitt 20 comprises a struck portion 21 to be hit, a grip 22 extending from a bottom of the struck portion 21, and a cover 23 put on the struck portion 21 and the grip 22.

The buffing cells 10 are preferred to have various sizes and to be irregularly and densely arranged so that bending between adjacent buffing cells 10 is not propagated in any direction. In this embodiment, the buffing cells 10 are arranged in two layers. Preferably, the buffing cells 10 in a middle portion of the mitt 20 are arranged more densely and have smaller sizes than those in a marginal portion of the mitt 20.

At the border between the struck portion 21 and the grip 22, a distance t2 of 2˜15 mm, preferably, of 3˜10 mm is formed between vinyl film portions of adjacent buffing cells 10. The cover 23 acts to prevent the vinyl film 13 being damaged or contaminated.

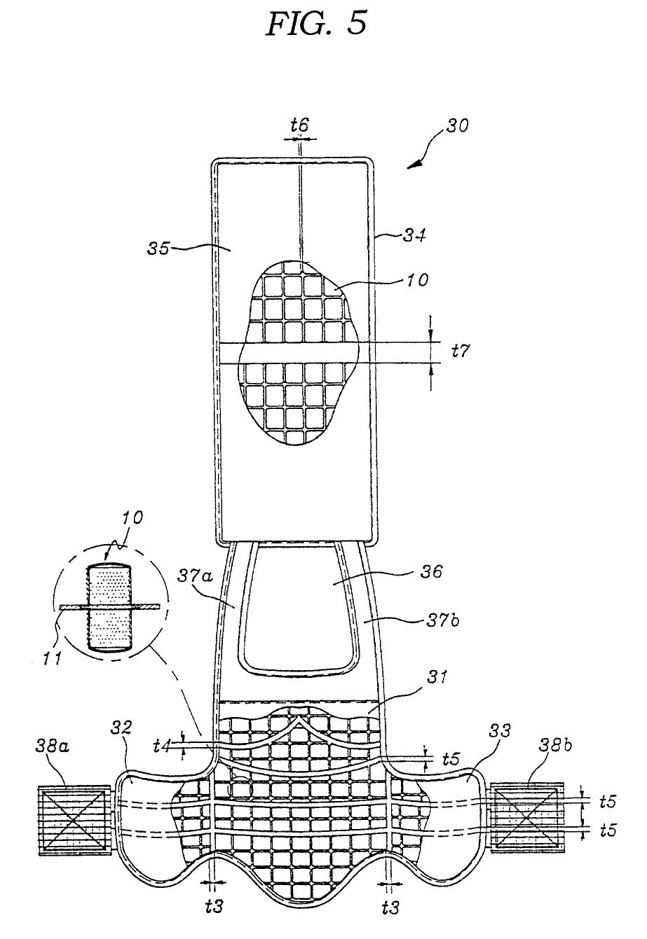

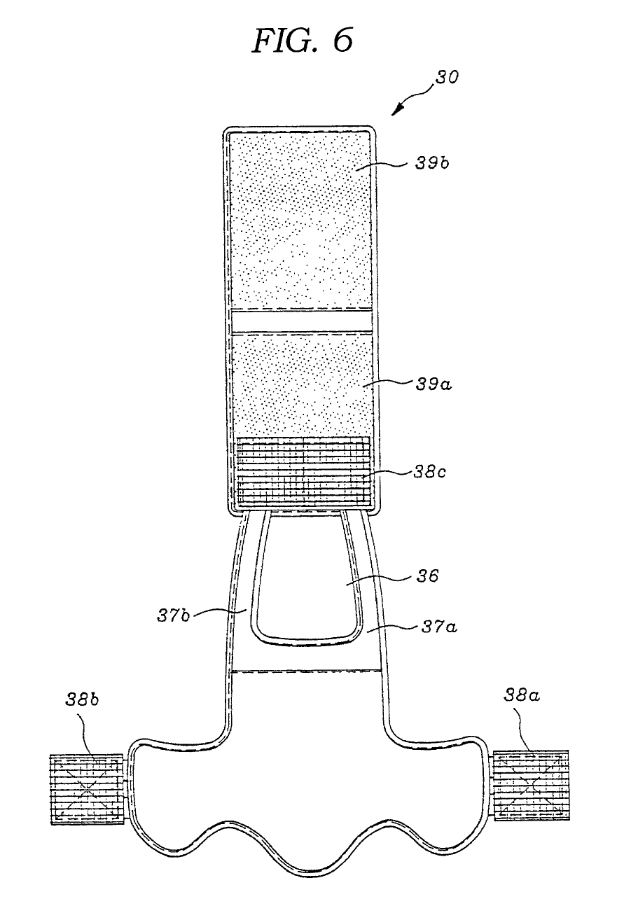

Furthermore, an upper body protector 30 made from the buffing cells 10 is showed in FIGS. 5 and 6.

The upper body protector 30 comprises a front part 31 to be put on the breast, a rear part 34 to be put on the back, and left and right parts 32 and 33 to be put on the left and right sides.

All of these parts 31, 32, 33 and 34 comprise a plurality of the buffing cells 10 connected with each other. The left part 32 is connected to the left side of the front part 31 so that vinyl film portions of adjacent buffing cells 10 are spaced at a distance t3 of 3˜20 mm, preferably, of 5˜15 mm. The right part 33 is connected to the right side of the front part 31 in a similar manner. The buffing cells 10 may be arranged in two layers as showed in FIG. 5.

In the front part 31, several bands along which vinyl film parts of the buffing cells 10 are spaced at a distance t4 or t5 of 3˜20 mm, preferably, of 5˜15 mm are formed. The front part 31 is easily bent along these bands to provide a wearer with a full activity.

A cover 35 is put on all of these parts 31, 32, 33 and 34 to prevent the vinyl film 13 being damaged or contaminated.

The front part 31 is connected with the rear part 34 through two shoulders 37a and 37b by which a head insertion opening 36 is defined.

Velcro fasteners 38a and 38b provided at ends of the left and right parts 32 and 33 are attached to Velcro fastener 39a provided on a surface of the rear part 34. In this embodiment, the rear part 34 is formed to be folded by bending a middle portion having a horizontal band along which vinyl film parts of the buffing cells 10 are spaced at a distance t7 of 40˜70 mm. In folded state, Velcro fastener 39b provided on a surface of one half of the rear part 34 is attached to Velcro fastener 38c provided on a surface of the other half of the rear part 34. It is preferred that Velcro fasteners 38a and 38b provided at ends of the left and right parts 32 and 33 are both-sided fasteners.

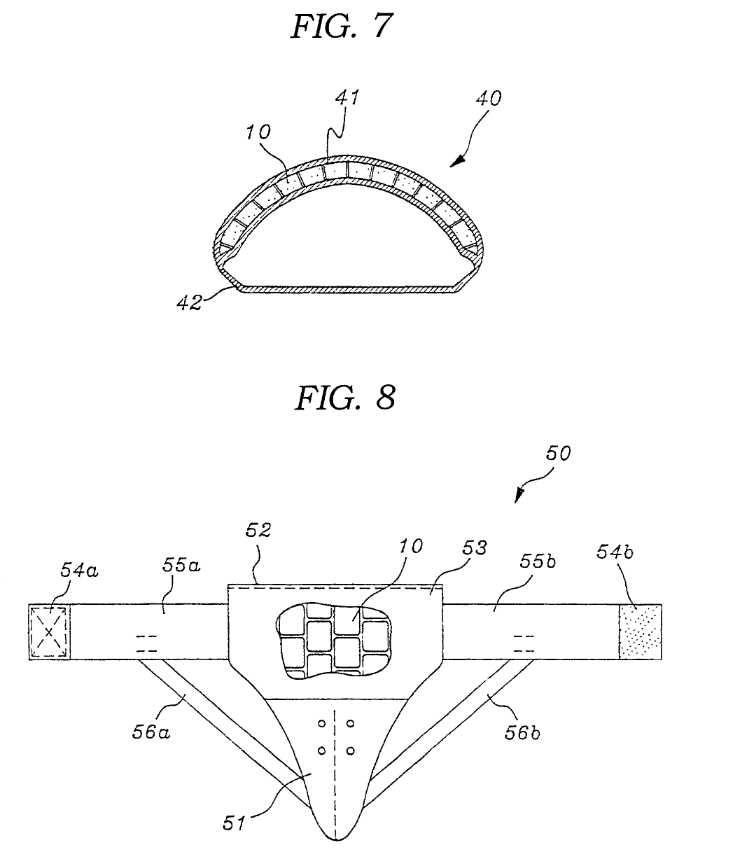

A forearm protector 40 made from the buffing cells 10 is showed in FIG. 7.

The forearm protector 40 comprises an impact-absorbing panel 41 to cover at least portions of the wrist and the shank, and a fastener 42 to closely fit the impact-absorbing panel 41 to the wrist and the shank.

A plurality of the buffing cells 10 are arranged in a longitudinal parallelism, while a band along which vinyl film parts of the buffing cells 10 are spaced at a desirable distance is provided around a joint between the wrist and the shank. In this embodiment, the fastener 42 consists of several rubber bands.

A groin protector 50 made from the buffing cells 10 is showed in FIG. 8.

The groin protector 50 comprises a groin cover 51 formed to be worn over the groin, and an impact-absorbing panel 52 extending from a top of the groin cover 51 to be put on the abdominal region. The groin cover 51 is formed as a hard unitary body to be hardly deformed by a foreign impact, while the impact-absorbing panel 52 is formed from a plurality of the buffing cells to be easily deformed. It is preferred that the buffing cells 10 are irregularly arranged. A cover 53 is put on the impact-absorbing panel 52 to prevent the vinyl film 13 being damaged or contaminated.

A pair of elastic fastening bands 55a and 55b are provided at the impact-absorbing panel 52 to be worn around the waist. The fastening bands 55a and 55b are connected by a pair of Velcro fasteners 54a and 54b with each other. The low end of the groin protector 50 is fixed by two elastic strings 56a and 56b.

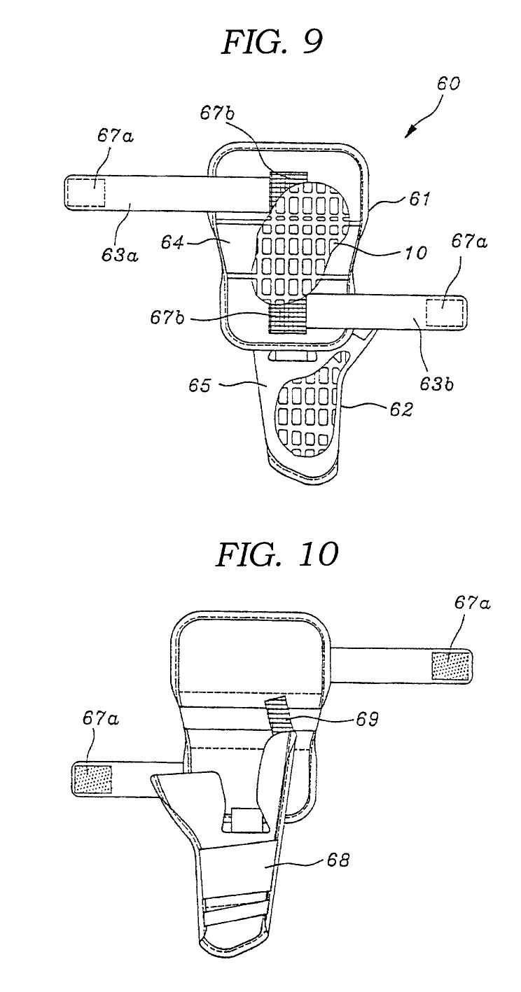

A shank protector 60 made from the buffing cells 10 is showed in FIGS. 9 and 10.

The shank protector 60 comprises an impact-absorbing panel 61 to be put on the shank, and another impact-absorbing panel 62 to be put on the ankle and the instep. Both impact-absorbing panels 61 and 62 are formed from a plurality of the buffing cells 10 arranged in a longitudinal parallelism. Preferably, the buffing cells 10 in a middle portion of the shank protector 60 are arranged more densely and have smaller sizes than those in a marginal portion of the shank protector 60. A cover 64 is put on the impact-absorbing panels 61 and 62 to prevent the vinyl film 13 being damaged or contaminated.

On an inside surface of the impact-absorbing panel 61, several elastic bands 63a and 63b having Velcro fasteners 67a and 67b are provided to be used in putting it on the shank protector 60. Furthermore, the impact-absorbing panel 62 is closely fitted on the instep by an elastic band 68 and Velcro fastener 69.

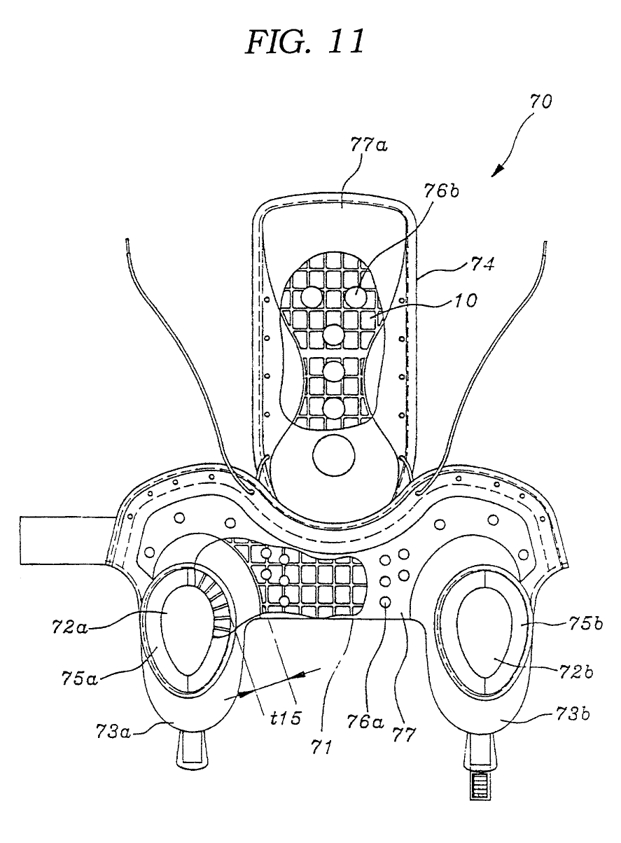

A head protector 70 made from the buffing cells 10 is showed in FIG. 11.

The head protector 70 comprises a first impact absorber 71 to be put on a circumference of the head, and a second impact absorber 74 formed to close a top opening surrounded by the first impact absorber 71. All of these impact absorbers 71 and 74 comprise a plurality of the buffing cells 10 connected with each other. In these impact absorbers 71 and 74, a plurality of air-through holes 76a and 76b are formed.

The first impact absorber 71 has two ear protectors 73a and 73b hung down through a band along which vinyl film parts of the buffing cells 10 are spaced at a distance t15 of 10˜50 mm. Each ear protector 73a or 73b defines an ear insertion opening 72a or 72b surrounded by a doughnut-shaped rim 75a or 75b. The rim 75a or 75b is formed from a row of buffing cells 10 that have an enough thickness to protrude beyond an auricle.

A cover 77 is put on all of these impact absorbers 71 and 74 to prevent the vinyl film 13 being damaged or contaminated. The head protector 70 also comprises strings and fasteners to be used in closely putting it on the head.

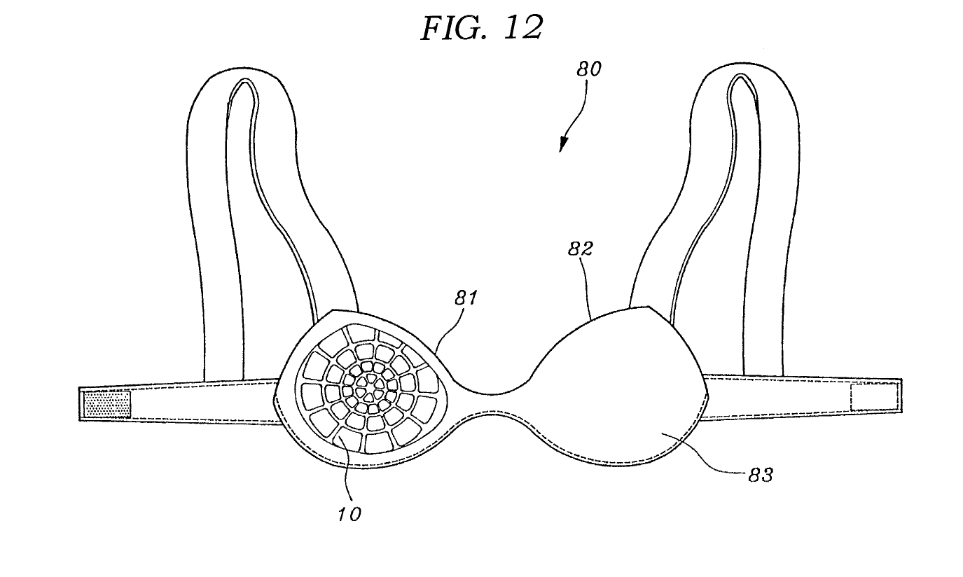

A breast protector 80 made from the buffing cells 10 is showed in FIG. 12.

The breast protector 80 comprises two cup-shaped impact absorbers 81 and 82 to be worn on the breasts of a woman. Each cup-shaped impact absorber 81 or 82 is formed from a plurality of the buffing cells 10. A cover 83 is put on all of these impact absorbers 81 and 82 to prevent the vinyl film 13 being damaged or contaminated. The breast protector 80 also comprises elastic strings and fasteners to be used in closely putting it on the breasts.

The buffing cell according to this invention damps an impact exerted on a face thereof by absorbing but not by dispersing the impact. Accordingly, the buffing cell can be divided into a plurality of small pieces without deteriorating damping effect. Dividing the buffing cell results in enhancing flexibility of an impact-absorbing panel formed from a plurality of the buffing cells. Furthermore, the buffing cell has a considerably small weight. A sports protector made from the buffing cells can provide a wearer with a full activity.

Although the above detailed explanation for the present invention is relied on several preferred embodiments, these are not for limiting but for exemplifying the present invention. Variable alterations, changes or modulations within the technical idea of the present invention will be apparent to one skilled in this technical field.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A buffing cell comprising a pneumatic chamber defined by flexible skins, and an elastically compressible layer associated with the pneumatic chamber.

2. A buffing cell according to claim 1, wherein said elastically compressible layer consists of an elastic member housed in the pneumatic chamber.

3. A buffing cell according to claim 1, wherein said elastically compressible layer consists of an elastic member attached on at least an outer face of the pneumatic chamber.

4. A sports protector consisting of a plurality of buffing cells connected with each other: wherein said buffing cells comprise skin members formed of flexible material, and an elastic member disposed among said skin members, respectively; wherein said skin members cooperate to define an airtight chamber with each other, in which said elastic member is contained; and wherein two adjoining cells are spaced at a distance in most part of the thickness except for only a thin connector.

5. A mitt consisting of a struck portion and a grip: wherein said struck portion comprise a plurality of buffing cells arranged in two layers, and a reinforced frame; wherein said grip comprise a plurality of buffing cells and a hard core; wherein said buffing cells comprise skin members formed of flexible material, and an elastic member disposed among said skin members, respectively; wherein said skin members cooperate to define an airtight chamber with each other, in which said elastic member is contained; and wherein two adjoining cells are spaced at a distance in most part of the thickness except for only a thin connector.

6. An upper body protector consisting of front, rear, left and right parts: wherein said front part is connected with said rear part at its top side, said left part at its left side and said right part at its right side; wherein a head insertion opening is formed between said front and rear parts; wherein said rear, left and right parts are connected with each other by attachable/detachable fasteners; wherein said front, rear, left and right parts comprise a plurality of buffing cells; wherein said buffing cells comprise skin members formed of flexible material, and an elastic member disposed among said skin members, respectively; wherein said skin members cooperate to define an airtight chamber with each other, in which said elastic member is contained; and wherein two adjoining cells are spaced at a distance in most part of the thickness except for only a thin connector.

7. An upper body protector according to claim 6, wherein said buffing cells are arranged in two layers.

8. A forearm protector comprising an impact-absorbing panel having area for surrounding at least a portion of the forearm: wherein said impact-absorbing panel consists of a plurality of buffing cells; wherein said buffing cells comprise skin members formed of flexible material, and an elastic member disposed among said skin members, respectively; wherein said skin members cooperate to define an airtight chamber with each other, in which said elastic member is contained; and wherein two adjoining cells are spaced at a distance in most part of the thickness except for only a thin connector.

9. A groin protector comprising a groin cover to be worn over the groin and an impact-absorbing panel formed to cover the abdominal region: wherein said impact-absorbing panel consists of a plurality of buffing cells; wherein said buffing cells comprise skin members formed of flexible material, and an elastic member disposed among said skin members, respectively; wherein said skin members cooperate to define an airtight chamber with each other, in which said elastic member is contained; and wherein two adjoining cells are spaced at a distance in most part of the thickness except for only a thin connector.

10. A shank protector comprising an impact-absorbing panel having area for surrounding at least a portion of the shank and another impact-absorbing panel having area for covering at least a portion of the instep: wherein both impact-absorbing panels consist of a plurality of buffing cells; wherein said buffing cells comprise skin members formed of flexible material, and an elastic member disposed among said skin members, respectively; wherein said skin members cooperate to define an airtight chamber with each other, in which said elastic member is contained; and wherein two adjoining cells are spaced at a distance in most part of the thickness except for only a thin connector.

11. A headgear comprising a first impact absorber formed to surround at least a side portion of the head and a second impact absorber formed to close a top opening surrounded by said first impact absorber: wherein two ear insertion openings are formed in said first impact absorber: wherein both impact absorbers consist of a plurality of buffing cells; wherein said buffing cells comprise skin members formed of flexible material, and an elastic member disposed among said skin members, respectively; wherein said skin members cooperate to define an airtight chamber with each other, in which said elastic member is contained; and wherein two adjoining cells are spaced at a distance in most part of the thickness except for only a thin connector.

12. A breast protector comprising two cup-shaped impact absorbers to be worn on the breasts of a woman: wherein both impact absorbers consist of a plurality of buffing cells; wherein said buffing cells comprise skin members formed of flexible material, and an elastic member disposed among said skin members, respectively; wherein said skin members cooperate to define an airtight chamber with each other, in which said elastic member is contained; and wherein two adjoining cells are spaced at a distance in most part of the thickness except for only a thin connector.
